(19) United States
(12) Patent Application Publication
(10) Pub. No.: US 2019/0248181 A1
(43) Pub. Date: Aug. 15, 2019

(54) Infrared Reflective Rubber Composition

(71) Applicant: PPG Industries Ohio, Inc., Cleveland, OH (US)

(72) Inventors: Rui Xu, Pittsburgh, PA (US); Lucas Dos Santos, Pittsburgh, PA (US); Anil Kumar, Murrysville, PA (US); Nathan Silvernail, Mars, PA (US)

(21) Appl. No.: 16/255,132

(22) Filed: Jan. 23, 2019

Related U.S. Application Data
(60) Provisional application No. 62/631,018, filed on Feb. 15, 2018.

(51) Int. Cl. B60C 1/00; C08L 9/06; G01S 17/02; G01S 7/481

(52) U.S. Cl. CPC B60C 1/00; C08L 9/06; C08L 2310/00; G01S 7/4814; C08L 2205/02; G01S 17/026

(57) ABSTRACT

A rubber composition includes rubber and an infrared (IR) reflective pigment. Upon contact with IR radiation having a wavelength in the range of 700 to 2500 nm, the rubber composition has a maximum IR reflectance of at least 30%. A Light Detection and Ranging (LIDAR) detectable tire includes a first section formed from the rubber composition. A method for detecting a LIDAR detectable tire is also disclosed.

### FIELD

The present invention relates to a rubber composition and a Light Detection and Ranging (LIDAR) detectable tire. The present invention also relates to a method and system for detecting a LIDAR detectable tire.

### BACKGROUND

Light Detection and Ranging (LIDAR) is a remote sensing method that uses short pulses of certain types of radiation, such as infrared (IR) radiation, to measure ranges and to detect the shape of objects. LIDAR technology is being used as part of navigation systems for autonomous vehicles.

The reliability of LIDAR detectors used on autonomous vehicles relies partially on IR signal reflection capability of the surface of objects in the path of the autonomous vehicle. If a surface absorbs IR light and has low IR reflectivity, it becomes difficult for the LIDAR detector to sense the object, which creates a danger for the autonomous vehicle.

Common obstructions to autonomous vehicles include other vehicles and road debris, such as tread of a truck tire that has experienced a blowout. Existing vehicle tires have low IR reflectivity because both the rubber and the carbon black filler typically included in conventional tires easily absorb IR light.

### SUMMARY

The present invention is directed to a rubber composition including rubber and an infrared (IR) reflective pigment. Upon contact with IR radiation having a wavelength in the range of 700 to 2500 nm, the rubber composition has a maximum IR reflectance of at least 30%.

The present invention is also directed to a Light Detection and Ranging (LIDAR) detectable tire including a first section formed from a rubber composition, the rubber composition including rubber and an infrared (IR) reflective pigment. Upon contact with IR radiation having a wavelength in the range of 700 to 2500 nm, the tire has a maximum IR reflectance of at least 30%.

The present invention is also directed to a method for detecting a Light Detection and Ranging (LIDAR) detectable tire including: emitting infrared (IR) radiation from a radiation source positioned such that at least a portion of the emitted IR radiation reflects off of a tire including a first section formed from a rubber composition, the rubber composition including: rubber; and an IR reflective pigment, where upon contact with the IR radiation having a wavelength in the range of 700 to 2500 nm, the rubber composition has a maximum IR reflectance of at least 30%; and detecting at least a portion of the reflected IR radiation with an IR radiation detector.

### BRIEF DESCRIPTION OF THE DRAWINGS

FIG. 1 shows a detection system for detecting a Light Detection and Ranging (LIDAR) detectable tire;

FIG. 2 shows another detection system for detecting a LIDAR detectable tire;

FIG. 3 shows a graph of IR reflectance at certain wavelengths for comparative rubber compositions;

FIG. 4 shows a graph of IR reflectance at certain wavelengths for rubber compositions of Comparative Examples 1 and 5 and Examples 6-11;

FIG. 5 shows a graph of IR reflectance at certain wavelengths for rubber compositions of Comparative Example 1 and Example 12;

FIG. 6 shows a graph of IR reflectance at certain wavelengths for rubber compositions of Comparative Example 1 and Examples 13-15;

FIG. 7 shows a graph of IR reflectance at certain wavelengths for rubber compositions of Comparative Example 1 and Examples 16-17; and

FIG. 8 shows a graph of IR reflectance at certain wavelengths for rubber compositions of Examples 9 and 19.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “an” additive, “a” silica, and the like refer to one or more of these items. Also, as used herein, the term “polymer” is meant to refer to prepolymers, oligomers, and both homopolymers and copolymers.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

The present invention is directed to a rubber composition including a rubber and an infrared (IR) reflective pigment. As used herein, the term “rubber composition” may refer to both uncured rubber compositions and cured rubber compositions. As used herein, the term “infrared radiation” refers to electromagnetic radiation in the IR range of the electromagnetic spectrum (i.e., having a wavelength in the range of 700 nm to 1,000,000 nm), such as near-infrared electromagnetic radiation having a wavelength in the range of 700-2500 nm, such as 800-1500 nm, such as 905 nm, or such as 1550 nm. For example, the IR reflective pigment may reflect radiation having a wavelength in the range of 700-2500 nm, such as 800-1500 nm, such as 905 nm, or such as 1550 nm.

The rubber may include natural rubber in its various raw and reclaimed forms. The rubber may include synthetic rubbers. The terms rubber composition, compounded rubber and rubber compound are used interchangeably to refer to rubber which has been blended or mixed with various ingredients and materials and such terms are well known to those having skill in the rubber mixing or rubber compounding art.

Representative synthetic rubbers may be the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form acrylonitrile butadiene rubber (NBR)), methacrylic acid and styrene, the latter compound polymerizing with butadiene to form styrene/butadiene rubber (SBR), as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, styrene/isoprene/butadiene rubber, copolymers of 1,3-butadiene or isoprene with monomers such as styrene, acrylonitrile or methyl methacrylate, as well as ethylene/propylene terpolymers, also known as ethylene/propylene/diene monomer (EPDM), and in particular, ethylene/propylene/dicyclopentadiene terpolymers. The preferred rubber or elastomers may be natural rubber, polybutadiene, and SBR.

The rubber may include at least two of diene-based rubbers. For example, a combination of two or more rubbers may include combinations of: cis 1,4-polyisoprene rubber, 3,4-polyisoprene rubber (3,4-PI), styrene/isoprene/butadiene rubber, emulsion and solution polymerization derived styrene/butadiene rubbers, cis 1,4-polybutadiene rubbers and emulsion polymerization prepared butadiene/acrylonitrile copolymers.

The rubber may include an emulsion polymerization derived styrene/butadiene rubber (E-SBR) having a styrene content of 10 to 28 percent bound styrene or, for some applications, an E-SBR having a bound styrene content of 30 to 45 percent. The styrene content of 30 to 45 for the E-SBR may be beneficial for enhancing traction, or skid resistance of a tire, for example. The presence of the E-SBR itself may be beneficial for enhancing processability of the uncured elastomer composition mixture.

By emulsion polymerization prepared E-SBR, it is meant that styrene and 1,3-butadiene may be copolymerized as an aqueous emulsion. The bound styrene content may vary, for example, from 5 to 50 percent. The E-SBR may also contain acrylonitrile to form a terpolymer rubber (E-SBAR). The terpolymer rubber may include 2 to 30 weight percent bound acrylonitrile in the terpolymer rubber.

Emulsion polymerization prepared styrene/butadiene/acrylonitrile copolymer rubbers containing 2 to 40 weight percent bound acrylonitrile in the copolymer are also contemplated as diene based rubbers for use in this invention.

The rubber may include solution polymerization prepared styrene/butadiene rubber (S-SBR). The S-SBR rubber may have a bound styrene content in a range of 5 to 50 weight percent, such as 9 to 36 weight percent. The S-SBR may be prepared, for example, by organo lithium catalyzation in the presence of an organic hydrocarbon solvent. A purpose of using S-SBR in a tire is for improved tire rolling resistance due to a resulting lower hysteresis.

Including 3,4-polyisoprene (PI) rubber in the rubber composition of a tire may be beneficial for enhancing the tire's traction when it is used in a tire tread. 3,4-PI and use thereof is more fully described in U.S. Pat. No. 5,087,668 which is incorporated herein by reference.

Cis 1,4-polybutadiene rubber (BR) included in the rubber of a tire may be beneficial for enhancing the tire tread's wear. Such BR may be prepared, for example, by organic solution polymerization of 1,3-butadiene. The BR may be characterized, for example, by having at least a 90 percent cis 1,4-content.

As previously mentioned, the rubber composition may include an IR reflective pigment. The term “IR reflective pigment” may refer to a pigment that, when included in a rubber composition, provides a rubber composition with a reflectance of IR radiation greater than the same rubber composition but without the IR reflective pigment.

The IR reflective pigment may include at least one of: Bragg scattering pigments, interference pigments, metal pigments, mixed metal pigments, metal oxide pigments, or combinations thereof.

Non-limiting examples of suitable IR reflective pigments include pigments sold by Ferro Corporation (Cleveland, Ohio) under the tradenames COOL COLORS and ECLIPSE. Such examples include: V-785 COOL COLORS IR BLACK (Iron Chromite Brown Hematite), V-760 COOL COLORS IR DARK BROWN (Iron Chromite Brown Hematite), 10245 ECLIPSE IR GREEN (Chromium Green-Black Hematite), V-12112 Bright Golden Yellow (Chrome Antimony Titanium BUFF Rutile), and combinations thereof.

As discussed above, the IR reflective pigment may include a metal oxide. The phrase “metal oxide” may include semi-metal oxides. The phrase “metal oxide” refers to oxygen containing species of various metals and/or semi-metals, such as aluminum, antimony, bismuth, boron, chrome, cobalt, gallium, indium, iron, lanthanum, lithium, magnesium, manganese, molybdenum, neodymium, nickel, niobium, silicon, tin, vanadium, or zinc. Examples of metal oxides that may be employed according to the invention include Cr₂O₃, Al₂O₃, V₂O₃, Ga₂O₃, Fe₂O₃, Mn₂O₃, Ti₂O₃, In₂O₃, TiBO₃, NiTiO₃, MgTiO₃, CoTiO₃, ZnTiO₃, FeTiO₃, MnTiO₃, CrBO₃, NiCrO₃, FeBO₃, FeMoO₃, FeSn(BO₃)₂, BiFeO₃, AlBO₃, Mg₃Al₂Si₃O₁₂, NdAlO₃, LaAlO₃, MnSnO₃, LiNbO₃, LaCoO₃, MgSiO₃, ZnSiO³, or Mn(Sb,Fe)O₃. Further examples of suitable IR reflective pigments may include (Cr,Fe)O₃, (Cr,Fe)O₂, (Cr,Sb,Ti)O₂, (Ni,Cr,Sb,Ti)O₂, (Ni,Sb,Ti)O₂, CoAl₂O₄, Cu(Cr,Fe)₂O₄, Co(Cr,Fe)₂O₄, Co(Cr,Al)₂O₄, (CoNiZn)₂(TiAl)O₄. Suitable metal oxide pigments may include those disclosed in US Patent Application Publication No. 2005/0215685, which is incorporated herein by reference. Mixtures of any of the aforementioned metal oxides may be included in the rubber composition.

The IR reflective pigment may exhibit a dark color visible to the human eye (e.g., visible radiation). As used herein, the term “visible radiation” refers to electromagnetic radiation in the visible range of the electromagnetic spectrum of 400-700 nm. As used herein, “dark color” means exhibiting an L* value of 0-40, such as 0-20, based on CIELAB values. Any CIELAB L*, a*, b*, C*, h°, and ΔE values reported herein were determined using an integrating sphere with D65 Illumination, 10° observer with specular component included according to ASTM 308 unless indicated otherwise. In the CIELAB color system, L* represents lightness/darkness on a scale of 0=pure black to 100=diffuse white, a* represents the balance of green −a* to red+a*, b* represents the balance of blue −b* to yellow+b*, C* represents chroma, and h° represents hue angle.

The IR reflective pigment may be included in the rubber composition in an amount from 0.01-30 parts per 100 parts of the rubber included in the rubber composition, such as 1-30 parts, such as 5-30 parts, such as 5-20 parts, such as 5-15 parts, such as 5-10 parts, such as 0.5-30 parts, such as 0.5-20 parts, such as 0.5-10 parts.

The rubber composition may further include an IR transparent pigment. The term “IR transparent pigment” may refer to a pigment that is substantially transparent to IR radiation, for example to radiation in the near-infrared range of 700 to 2500 nm, such as is described in U.S. Patent Application Publication No. 2004/0191540 at [0020]-[0026], the cited portion of which is incorporated herein by reference, without appreciable scattering or absorption of radiation in such wavelengths. In certain examples, the IR transparent pigment may have an average transmission of at least 70% in the IR wavelength region.

Non-limiting examples of suitable IR transparent pigments may include, for example, copper phthalocyanine pigment, halogenated copper phthalocyanine pigment, anthraquinone pigment, quinacridone pigment, perylene pigment, monoazo pigment, disazo pigment, quinophthalone pigment, indanthrone pigment, dioxazine pigment, isoindoline pigment, diarylide yellow pigment, brominated anthranthrone pigment, azo metal complex pigment, and the like. Combinations of the IR transparent pigments may be used.

The IR transparent pigment may include an IR transparent black pigment, such as those that rely in part upon a perylene type structure that is illustrated below:

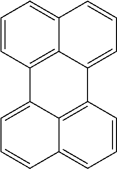 [SMILES: c1cc2cccc3c4cccc5cccc(c(c1)c23)c54]

Commercially available examples of such pigments include PALIOGEN Black EH 0788, PALIOGEN Black L0086, and PALIOGEN Black S0084, commercially available from BASF Corporation (Ludwigshafen, Germany). Further examples of IR transparent black pigments that are suitable for use in certain embodiments of the present invention are described in U.S. Patent Application Publication No. 2009/0098476 at [0030] to [0034], the cited portion of which is incorporated by reference herein, and includes those having a perylene isoindolene structure, an azomethine structure, and/or an aniline structure.

The IR transparent pigment may exhibit a dark color visible to the human eye (for example, exhibiting an L* value of 0-40, such as 0-20, based on CIELAB values).

The rubber composition may further include a filler. The filler may include silica. Siliceous pigments used in rubber compounding applications may be used as the silica in this invention, including pyrogenic and precipitated siliceous pigments (silica). Precipitated silicas may include, for example, those obtained by the acidification of a soluble silicate, e.g., sodium silicate.

Such silicas might be characterized, for example, by having a BET surface area, as measured using nitrogen gas, preferably in the range of 40 to 600, and such as in a range of 50 to 300 square meters per gram. The BET method of measuring surface area is described in the Journal of the American Chemical Society,Volume 60, page 304 (1938). The silica may also be characterized by having a dibutylphthalate (DBP) absorption value in a range of 100 to 400, and such as 150 to 300.

Further, the silica may have a CTAB surface area in a range of 100 to 220. The CTAB surface area is the external surface area as evaluated by cetyl trimethylammonium bromide with a pH of 9. The method for determining CTAB surface area is described in ASTM D 3849 for set up and evaluation.

The average mercury porosity specific surface area for the silica may be in a range of 100 to 300 m²/g. Mercury surface area/porosity is the specific surface area determined by Mercury porosimetry. For such technique, mercury is penetrated into the pores of the sample after a thermal treatment to remove volatiles. Set-up conditions may be suitably described as using a 100 mg sample; removing volatiles over 2 hours at 105° C. and ambient atmospheric pressure; ambient to 2000 bars pressure measuring range. Such evaluation may be performed according to the method described in Winslow, Shapiro in ASTM bulletin, p. 39 (1959) or according to DIN 66133. For such an evaluation, a CARLO-ERBA Porosimeter 2000 might be used.

A suitable pore-size distribution for the silica according to such mercury porosity evaluation is considered herein to be five percent or less of its pores have a diameter of less than 10 nm; 60 to 90 percent of its pores have a diameter of 10 to 100 nm; 10 to 30 percent of its pores have a diameter of 100 to 1000 nm; and 5 to 20 percent of its pores have a diameter of greater than 1000 nm.

The silica may have an average ultimate particle size, for example, in the range of 10 to 200 microns, such as 20 to 100 microns, or 30 to 50 microns, as determined by an electron microscope, although the silica particles may be smaller or larger in size.

Silica suitable for the invention may include precipitated silica, colloidal silica, and fumed silica. Particularly suitable for the invention are precipitated silicas. Commercially available examples of pelletized, granulated, and/or powdered silicas include those available under the tradename HI-SIL from PPG Industries, Inc. (Pittsburgh, Pa.), such as HI-SIL 190, HI-SIL 210, HI-SIL 215, HI-SIL 233 HI-SIL 243, HI-SIL EZ160GD, and the like; those available under the tradename FLO-GARD from PPG Industries, Inc. (Pittsburgh, Pa.), such as FLO-GARD SP, FLO-GARD LP, and the like; those available under the tradename ULTRASIL from Degussa AG (Essen, Germany), such as ULTRASIL VN2, ULTRASIL VN3, and the like; PERKASIL KS 300-PD from Grace Materials Technologies (Columbia, Md.); ZEOSIL 1165 MP from Solvay S. A. (Brussels, Belgium), and other silicas available from J. M. Huber Corporation (Edison, N.J.).

The silica may include treated silica. Examples of suitable treated silicas include those disclosed in U.S. Pat. No. 9,688,784, which is incorporated herein by reference. Other examples of suitable treated silicas include those disclosed in U.S. Pat. No. 8,846,806, columns 5 through 8, which is incorporated herein by reference. Further examples of treated silicas include powdered silicas that have been functionalized with a pre-surface treatment with a silane, such as the following commercially available examples: CIPTANE 255 LD and CIPTANE LP from PPG Industries, Inc. (Pittsburgh, Pa.), which are powdered silicas that have been pre-treated with a mercaptosilane; COUPSIL 8113 from Degussa AG (Essen, Germany), which is the product of the reaction between organosilane bis(triethoxysilylpropyl) polysulfide (SI-69) and ULTRASIL VN3 silica. CIPTANE I and CIPTANE TM are pelletized versions of the powdered pre-treated CIPTANE silicas above and are also examples of suitable treated silicas. Another chemically-modified precipitated amorphous silica that may be used in the present invention is AGILON 400 from PPG Industries Inc. (Pittsburgh, Pa.).

The silica may be treated with at least one of the previously described IR reflective pigments and/or IR transparent pigments prior to mixing with the rubber of the rubber composition. The silica may be treated with an IR reflective pigment and/or IR transparent pigment by adding the IR reflective and/or IR transparent pigment during the precipitation step of silica production. Alternatively, the IR reflective and/or IR transparent pigment may be added to the silica slurry after precipitation, then spray dried together to form the pigment treated silica.

The filler may be included in the rubber composition in amounts ranging from 10-250 parts (per 100 parts of the rubber in the rubber composition), such as 15-100 parts.

The rubber composition may further include a silane coupler to covalently bond the silica filler to the rubber to improve mechanical strength of the rubber composition.

The rubber composition may include further additives (in addition to the previously described pigments). The additive may include sulfur donors, curing aids, such as activators and/or retarders, and/or processing additives, such as oils, resins including tackifying resins, and/or plasticizers, modified starches, fatty acid, zinc oxide, waxes, antioxidants and/or antiozonants, and/or peptizing agents.

The rubber composition may include less than 1 weight percent carbon black, such as less than 0.5 weight percent. The rubber composition may be completely free of carbon black, meaning that the rubber composition includes no carbon black.

The rubber composition may reflect IR radiation upon contact with such IR radiation. For example, the rubber composition may reflect IR radiation having a wavelength in the range of 700-2500 nm, such as 800-1500 nm, such as 905 nm, or such as 1550 nm. The rubber composition may reflect at least 30% of the contacting IR radiation, such as at least 40% or at least 45%. The rubber composition may have a higher IR reflectance compared to the same rubber composition not including the IR reflective pigment. The rubber composition may have a higher IR reflectance compared to the same rubber composition except with the IR reflective pigment replaced with carbon black.

The rubber composition may be produced by mixing the IR reflective pigments with the rubber and the filler (if applicable). The mixing of the rubber composition may be accomplished by methods known to those having skill in the rubber mixing art, such as mixing the various sulfur-vulcanizable constituent rubbers with various additives. The ingredients may be mixed in at least two stages, such as, at least one non-productive stage followed by a productive mix stage.

Final curatives, including sulfur-vulcanizing agents, may be mixed in the productive mix stage in which the mixing may occur at a temperature, or ultimate temperature, lower than the mix temperature(s) used in the preceding non-productive mix stage(s). The terms non-productive and productive mix stages are well known to those having skill in the rubber mixing art. The rubber composition may be subjected to a thermomechanical mixing step. The thermomechanical mixing step may include a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The mixture may be milled, extruded, and cured to form the end product including the rubber composition.

The rubber composition may be vulcanized at a temperature ranging from 100° C. to 200° C. The vulcanization may be conducted at a temperature ranging from 110° C. to 180° C. Any vulcanization process known in the art may be used, such as heating in a press or mold, or heating with superheated steam or hot air. Such rubber compositions may be built, shaped, molded and cured into the end product including the rubber composition by various methods which are known and will be readily apparent to those having skill in such art.

The rubber composition may be used in any suitable product. For example, the rubber composition may be used in vehicle tires or other industrial rubber products. In the case of the rubber composition being included in a tire, the tire may include a first section that includes the rubber composition. The first section of the tire may include at least one of a tire tread, such as a tread cap or a tread base, a tire sidewall, a tire apex, a tire chafer, a tire sidewall insert, or a tire wirecoat. In some examples, the first section includes the entire tire. In other examples, the tire includes a second section formed of a different rubber composition compared to the first section. The rubber composition included in this second section may include rubber and carbon black. The tire formed using the rubber composition of the present invention may be referred to herein as a “Light Detection and Ranging (LIDAR) detectable tire” or “LIDAR tire”.

The tire may be included on a vehicle. The vehicle may be any type of vehicle including at least one rubber tire. The vehicle may include an automobile, a bicycle, a motorcycle, a truck, an aircraft, an agricultural earthmover, an off-road vehicle, and the like.

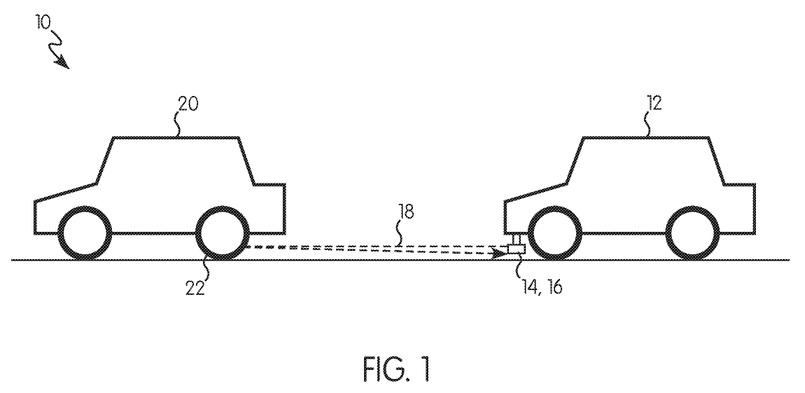

Referring to FIG. 1, a detection system 10 for detecting the LIDAR tire according to the present invention is shown. The detection system 10 may include a vehicle, such as an autonomous vehicle 12. The autonomous vehicle 12 may include and IR source 14 configured to emit IR radiation 18 and an IR detector 16 configured to detect IR radiation 18.

The IR source 14 that may be used in the present invention may include, without limitation, light emitting diodes (LEDs), laser diodes, or any light source that is capable of emitting the IR radiation 18. For example, the IR radiation 18 may include at least one wavelength in the near-infrared range from 700-2500 nm. The IR source 14 may be used in an imaging LIDAR (Light Imaging, Detection and Ranging) system. The IR source 14 may utilize lasers to generate electromagnetic radiation, such as the IR radiation 18. For example, the IR radiation 18 may have a wavelength in the near-infrared range from 700-2500 nm, such as from 800-1500 nm, such as wavelengths of 905 nm, 1550 nm, or any other suitable wavelength in the IR range.

An IR detector 16 may include a semiconductor detector that is capable of sensing the reflected IR radiation 18. Such IR detectors 16 may include a photodiode or an image sensor. The IR detector 16 may be a LAMBDA 950 or LAMBDA 1050 spectrophotometer, commercially available from PerkinElmer, Inc. (Waltham, Mass.) or any other suitable IR detecting device. The IR detector 16 may be coupled in the same housing unit with the IR source 14 (as shown in FIG. 1), such as a LIDAR system that houses both the IR source 14 and the IR detector 16. Alternatively, the IR detector 16 may be in a separate housing from the IR source 14.

With continued reference to FIG. 1, the detection system 10 may include a second vehicle 20, and the second vehicle 20 may include at least one of the previously discussed LIDAR tires 22. The second vehicle 20 may be in the path of the autonomous vehicle 12. The second vehicle 20 may be any conventional vehicle. For example, the second vehicle 20 may be an autonomous vehicle.

The IR source 14 and IR detector 16 may be positioned on the autonomous vehicle 12 as shown in FIG. 1, or they may be positioned in any other suitable position on the autonomous vehicle 12. The IR source 14 may be positioned on the autonomous vehicle 12 such that at least a portion of the IR radiation 18 emitted from the IR source 14 reflects off of the LIDAR tire 22 of the second vehicle 20. The IR detector 16 may be positioned on the autonomous vehicle 12 such that the IR detector 16 detects at least a portion of the IR radiation 18 reflected off of the LIDAR tire 22 of the second vehicle 20.

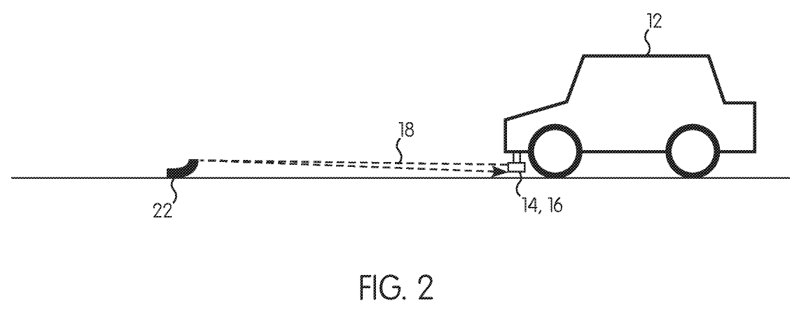

Referring to FIG. 2, another detection system 30 for detecting the LIDAR tire 22 according to the present invention is shown. The detection system 30 of FIG. 2 is identical to the detection system 10 of FIG. 1, except the detection system 30 in FIG. 2 does not include the second vehicle 20 in the path of the autonomous vehicle 12. In the example shown in FIG. 2, the LIDAR tire 22 may be a portion of the LIDAR tire 22 that remains on a roadway in the path of the autonomous vehicle 12 as road debris. It will be appreciate that the LIDAR tire 22 may be replaced by other objects commonly in the path of the autonomous vehicle 12 that are formed from the inventive rubber composition disclosed herein. Non-limiting examples of other objects formed from the inventive rubber that may be detected by the detection system 10, 30 include: non-tire rubber debris, road signage including rubber, miscellaneous road construction barriers including rubber, human clothing (e.g., shoes), and the like.

### EXAMPLES

The following examples are presented to demonstrate the general principles of the invention. The invention should not be considered limited as to the specific examples presented. All parts and percentages in the examples are by weight unless otherwise indicated.

### General Procedures

The preparation of the rubber composition in this invention are detailed in the examples below. Generally, the formulations were mixed using two non-productive passes and sheeted off between each pass to 0.085 inches (2.16 mm). The material was allowed to cool for at least one hour between passes and followed by a mill finish on a two roll mill. A Brabender Electronic PLASTI-CORDER Prep Mixer equipped with a 350/420 mL volume mixing head containing Banbury blades as well as an oil heated with a heat exchanger and a Farrel 12 inch two-roll rubber mill were used for mixing the ingredients following ASTM D3182-89.

To produce each of the Masterbatches in the first pass, the mixer speed was adjusted to 70 rpm, the mixer temperature adjusted to 85° C., and both the solution styrene butadiene rubber (S-SBR) and butadiene rubber (BR) were added to the mixer. After 30 seconds approximately half of the test silica and the silane coupler were added to the mixer. For each Example and Comparative Example, the indicated amount of carbon black and/or IR reflective pigment(s) were also added to the mixer at this point. After a further 30 seconds into the mix cycle, the remaining silica as well as the processing oil were added to the mixer. After another 30 seconds into the mix cycle, the ram was raised and the chute swept, i.e., the covering on the entry chute was raised and any material that was found in the chute was swept back into the mixer and the ram lowered. From 120 seconds into the mix cycle forward the mixer speed was adjusted to reach and/or maintain a temperature of 160° C.+/−3° C. for 180 seconds. The first pass was dropped at a temperature of 160° C.+/−3° C. after approximately 300 seconds of total mix time.

For the second pass the mixer speed was adjusted to 70 rpm, the mixer temperature was adjusted to 85° C. and the cooled first pass Masterbatch and zinc oxide were added to the mixer. After 60 seconds the remainder of ingredients listed under the second pass were added. After another 30 seconds the ram was raised and the chute swept. From 90 seconds into this second mix cycle forward the mixer speed was adjusted to reach and/or maintain a temperature of 160° C.+/−3° C. for 150 seconds. This second pass was dropped at a temperature of 160° C.+/−3° C. after approximately 240 seconds of total mix time.

For the mill finish, all the ingredients listed were blended into the cooled second pass product on a two-roll rubber mill. Milling was done for approximately 3 minutes performing 5 side cuts and 5 end passes.

The sample was cut and conditioned, i.e., stored between clean polyethylene sheets and maintained for 15 to 18 hours at a temperature of 23° C.±2° C., and a relative humidity of 50%±5%.

After conditioning, the sample was placed in a 203.2 mm×152.4 mm×2.286 mm (8 inch×6 inch×0.09 inch) standard frame machine steel compression mold having a polished surface. The sample was cured in a 61 centimeter×61 centimeter (24 inch×24 inch) 890 kiloNewtons (100 ton) 4-post electrically heated compression press, for T90, i.e., the time it takes for 90 percent of the cure to occur, in accordance with ASTM D-2084, plus 5 minutes at 150° C. (302° F.) under a pressure of 13.79 megaPascals (2000 pounds per square inch). Typically, curing was completed within about 10 minutes. The resulting cured rubber sheet was removed from the mold and maintained for 15 to 18 hours at a temperature of 23° C.±2° C. (73.4° F.±3.6° F.), and a relative humidity of 50%±5%.

Percent reflectance measurements were performed using a Perkin Elmer LAMBDA 1050 spectrophotometer using a 150 mm integrating sphere. The angle of incidence is 8 degrees from normal. The sample port for reflectance was a 1 inch circle and the cured rubber samples were cut into sizes of 2 in×2 in up to 4 in×4 in (and flat). Percent reflectance is calculated by measuring the strength of the reflecting light to that of the incident light: % R=100×I/I₀. The following correction procedure for reflectance is done by the instrument software to obtain the final reflectance % R for each wavelength recorded: % R=% R*×(S−Z)/(B−Z)

Where:

S=the sample recording (with sample in reflectance port)

Z=the zero recording (with light trap in reflectance port)

B=the 100% or baseline recording (with reference mirror in reflectance port)

% R*=the known reflectance of the reference mirror, which was determined using a

VW absolute reflectance accessory on the LAMBDA 1050 spectrophotometer

Mechanical properties were tested and showed for the rubber compound using pigment treated silica prior to adding in the mixer during rubber preparation. G′ and tan (δ) were measured using an ARES G2 rheometer, at the conditions specified in Table 12. Hardness was measured according to ASTM D2240-2010. Rebound was measure according to ISO 4662. Hardness and rebound at 100° C. were measured by heating the samples at 100° C. for 30 minutes and performing the measurements according to the corresponding standard as soon as the samples were removed from the oven. Tensile properties were measured according to ASTM D-412 Test Method A. Tensile properties at 100° C. were measured by heating the samples at 100° C. for 10 min prior to performing the measurements. Cure profile parameters (S′max, S′min, S′max-S′min and T50) were measured with a moving die rheometer (MDR) at 150° C.

The examples are displayed in the following order: First, comparative examples demonstrating rubber compositions containing carbon black are shown. The samples showed very low IR reflectance. Then, the examples of a series of rubber compositions are shown to demonstrate that the IR reflectance of a rubber compound was significantly improved by replacing all of the carbon black with an IR reflective pigment with a black color. The following example shows that silica was treated with an IR reflective pigment prior to the preparation of rubber compositions. In the end, examples of rubber compounds using various IR reflective pigments are demonstrated.

### Comparative Examples 1-5

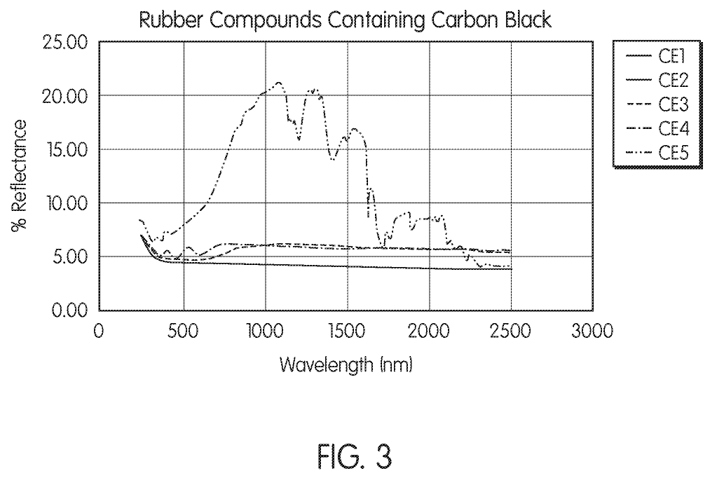

Rubber compounds containing various amounts of carbon black with or without IR reflective pigments are shown. These rubber compounds were prepared using the method detailed in General Procedures according to the formulations shown in Table 1. From the comparison of the IR reflectance test results shown in Table 2 and FIG. 3, it can be seen that rubber compounds containing carbon black have very low IR reflectance, even if the carbon black amount is as low as 1 part. Adding IR reflective pigments to a rubber compound containing as low as 1 part carbon black has a negligible effect on IR reflectance. A rubber compound removing all carbon black and replacing with additional silica gives a maximum baseline reflectance % R peak value of 21.05. For reference, a typical formulation for a rubber tire would be similar to Comparative Example 1, but contain significantly higher carbon black.

TABLE 1
Rubber compounds compositions containing carbon black

| | Comparative | Comparative | Comparative | Comparative | Comparative |
|---|---|---|---|---|---|
| | Example 1 | Example 2 | Example 3 | Example 4 | Example 5 |
| | 10 parts CB | 5 part CB | 5 part CB | 1 part CB | 0 part CB |
| Pass 1 | 0 part | 0 part | 30 part V- | 10 parts | 0 part |
| MasterBatch | pigment | pigment | 785 | 10245 | pigment |
| S-SBR BUNA VSL | 129.95 | 140.64 | 136.70 | 128.57 | 129.82 |
| 5228-2 Rubber¹, g | | | | | |
| BR BUDENE 1207 | 31.51 | 34.10 | 33.15 | 31.18 | 31.48 |
| Rubber², g | | | | | |
| Precipitated Silica³, | 88.23 | 102.31 | 99.44 | 98.51 | 100.73 |
| g | | | | | |
| Carbon Black⁴, g | 12.60 | 6.82 | 6.63 | 1.25 | — |
| V-785 Pigment⁵, g | — | — | 39.78 | — | — |
| 10245 Pigment⁶, g | — | — | — | 12.47 | — |
| Silane Coupler⁷, g | 7.06 | 8.73 | 8.49 | 8.38 | 8.56 |
| VIVATEC 500⁸, g | 6.30 | 6.82 | 6.63 | 6.24 | 6.30 |
| Pass 2 | | | | | |
| Master Batch, g | 267.94 | 291.06 | 321.83 | 278.66 | 269.15 |
| Zinc Oxide⁹, g | 3.06 | 3.31 | 3.22 | 3.03 | 3.06 |
| Stearic Acid¹⁰, g | 1.23 | 1.33 | 1.29 | 1.21 | 1.22 |
| SANTOFLEX 13 | 2.45 | 2.65 | 2.58 | 2.43 | 2.45 |
| (6PPD)¹¹, g | | | | | |
| Wax¹², g | 1.84 | 1.99 | 1.93 | 1.82 | 1.84 |
| Mill Finish | | | | | |
| Master Batch, g | 271.26 | 294.63 | 324.74 | 281.74 | 272.44 |
| Rubber Makers | 1.68 | 1.82 | 1.77 | 1.67 | 1.68 |
| Sulfur¹³, g | | | | | |
| SANTOCURE | 2.04 | 2.21 | 2.15 | 2.02 | 2.04 |
| CBS¹⁴, g | | | | | |
| DPG¹⁵, g | 2.40 | 2.60 | 2.53 | 2.38 | 2.40 |

¹Styrene butadiene rubber containing both oil and rubber, with 75 parts rubber, commercially available from Lanxess Aktiengesellschaft (Cologne, Germany)
²Butadiene rubber, commercially available from Goodyear International Corporation (Akron, OH)
³HI-SIL EZ160G, commercially available from PPG Industries, Inc. (Pittsburgh, PA)
⁴Carbon black N-330, commercially available from Continental Carbon Company (Houston, TX)
⁵V-785 COOL COLORS IR BLACK (Iron Chromite Brown Hematite) having a black color, commercially available from Ferro Corporation (Cleveland, OH)
⁶10245 ECLIPSE IR GREEN (Chromium Green-Black Hematite) having a green color, commercially available from Ferro Corporation (Cleveland, OH)
⁷Si 69 silane coupler, commercially available from Evonik Industries (Essen, Germany)
⁸VIVATEC 500 TDAE processing oil, commercially available from Hansen & Rosenthal KG (Hamburg, Germany)
⁹KADOX surface treated zinc oxide, commercially available from Harwick Standard Distribution Corp. (Akron, OH).
¹⁰Rubber grade stearic acid, commercially available from R.E. Carroll Inc. (Ewing, NJ)
¹¹An antiozonant reported to be N-(1,3-dimethylbutyl)-N′-phenyl-p-phenylenediamine, commercially available from Flexsys, a division of Solutia Inc. (St. Louis, MO)
¹²SUNPROOF IMPROVED antiozonant hydrocarbon wax, commercially available from Addivant (Danbury, CT)
¹³Rubber Makers sulfur (“RM sulfur”), 100% active, commercially available from Harwick Standard Distribution Corp. (Akron, OH)
¹⁴n-cyclohexyl-2-benzothiazolesulfenamide, commercially available from Flexsys, a division of Solutia Inc. (St. Louis, MO)
¹⁵Diphenylguanidine (DPG), commercially available from Harwick Standard Distribution Corp. (Akron, OH)

TABLE 2
IR reflectance (peak) of as-prepared rubber compounds

| | Peak % R | |
|---|---|---|
| | (700 nm-2500 nm) | |
| Comparative | 4.12 | 10 parts CB |
| Example 1 | | 0 part pigment |
| Comparative | 4.12 | 5 part CB |
| Example 2 | | 0 part pigment |
| Comparative | 6 | 5 part CB |
| Example 3 | | 30 part V-785 |
| Comparative | 6.22 | 1 part CB |
| Example 4 | | 10 parts 10245 |
| Comparative | 21.05 | 0 part CB |
| Example 5 | | 0 part pigment |

### Examples 6-11

### Rubber Composition Containing V-785 COOL COLORS IR BLACK Pigment

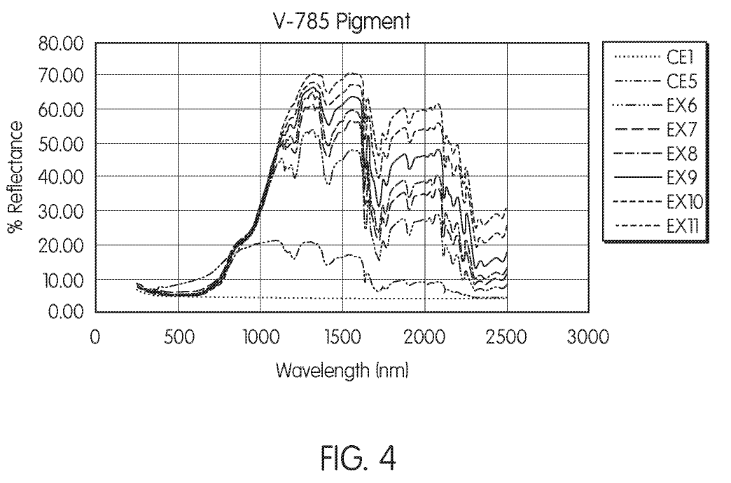

Rubber compounds containing various amounts of V-785 COOL COLORS IR BLACK Pigment (from Ferro Corporation) and no carbon black are shown. These rubber compounds were prepared using the method detailed in General Procedures using the formulations in Table 3. From the comparison of the IR reflectance test results shown in Table 4 and FIG. 4, it can be seen that by replacing carbon black with the IR reflective pigment, the IR reflectance of the rubber compounds significantly increased from 4.12 (Comparative Example 1) to around 60. For the sample in which only 1 part of V-785 Pigment was added to replace all of the carbon black, the % R peak value can still reach 53.7.

TABLE 3
Rubber compounds compositions containing V-785 Pigment

| | Example 6 | Example 7 | Example 8 | Example 9 | Example 10 | Example 11 |
|---|---|---|---|---|---|---|
| | 0 part CB | 0 part CB | 0 part CB | 0 part CB | 0 part CB | 0 part CB |
| | 1 part | 2 parts | 3 parts | 5 parts | 10 parts | 15 parts |
| | V-785 | V-785 | V-785 | V-785 | V-785 | V-785 |
| Pass 1 | | | | | | |
| MasterBatch | | | | | | |
| S-SBR BUNA | 129.69 | 129.57 | 129.44 | 129.19 | 139.36 | 138.70 |
| VSL 5228-2 | | | | | | |
| Rubber¹, g | | | | | | |
| BR BUDENE | 31.45 | 31.42 | 31.39 | 31.33 | 33.79 | 33.63 |
| 1207 Rubber², g | | | | | | |
| Precipitated | 100.63 | 100.54 | 100.44 | 100.25 | 108.14 | 107.63 |
| Silica³, g | | | | | | |
| V-785 Pigment⁵, g | 1.26 | 2.51 | 3.77 | 6.27 | 13.52 | 20.18 |
| Silane Coupler⁷, g | 8.55 | 8.55 | 8.54 | 8.52 | 9.19 | 9.15 |
| VIVATEC 500⁸, g | 6.29 | 6.28 | 6.28 | 6.27 | 6.76 | 6.73 |
| Pass 2 | | | | | | |
| Master Batch, g | 270.12 | 271.09 | 272.06 | 273.99 | 302.17 | 307.32 |
| Zinc Oxide⁹, g | 3.06 | 3.05 | 3.05 | 3.05 | 3.29 | 3.27 |
| Stearic Acid¹⁰, g | 1.22 | 1.22 | 1.22 | 1.22 | 1.31 | 1.31 |
| SANTOFLEX | 2.45 | 2.44 | 2.44 | 2.44 | 2.63 | 2.62 |
| 13 (6PPD)¹¹, g | | | | | | |
| Wax¹², g | 1.83 | 1.83 | 1.83 | 1.83 | 1.97 | 1.96 |
| Mill Finish | | | | | | |
| Master Batch, g | 273.39 | 274.34 | 275.28 | 277.17 | 305.50 | 310.54 |
| Rubber Makers | 1.68 | 1.68 | 1.68 | 1.67 | 1.81 | 1.80 |
| Sulfur¹³, g | | | | | | |
| SANTOCURE | 2.04 | 2.04 | 2.04 | 2.03 | 2.19 | 2.18 |
| CBS¹⁴, g | | | | | | |
| DPG¹⁵, g | 2.40 | 2.40 | 2.39 | 2.39 | 2.58 | 2.57 |

TABLE 4
IR reflectance (peak) of as-prepared rubber compounds

| | Peak % R | |
|---|---|---|
| | (700 nm-2500 nm) | |
| Comparative | 4.12 | 10 parts CB |
| Example 1 | | 0 part pigment |
| Comparative | 21.05 | 0 part CB |
| Example 5 | | 0 part pigment |
| Example 6 | 53.7 | 0 part CB |
| | | 1 part V-785 |
| Example 7 | 61.29 | 0 part CB |
| | | 2 parts V-785 |
| Example 8 | 65.33 | 0 part CB |
| | | 3 parts V-785 |
| Example 9 | 67.26 | 0 part CB |
| | | 5 parts V-785 |
| Example 10 | 67.26 | 0 part CB |
| | | 10 parts V-785 |
| Example 11 | 69.89 | 0 part CB |
| | | 15 parts V-785 |

### Example 12

### Rubber Composition Containing V-760 COOL COLORS IR DARK BROWN Pigment

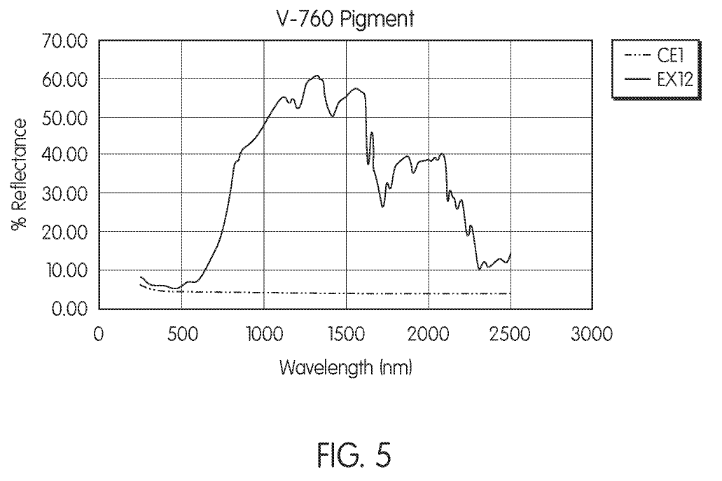

A rubber sample containing 5 parts of V-760 COOL COLORS IR DARK BROWN Pigment (from Ferro Corporation) and no carbon black is shown. The rubber compound was prepared using the method detailed in General Procedures using the formulation shown in Table 5. The IR reflectance test result was shown in Table 6 and FIG. 5. Compared to Comparative Example 1, it can be seen that by replacing carbon black with the IR reflective pigment, the IR reflectance of the rubber composition was significantly increased.

TABLE 5
Rubber compounds compositions containing V-760 Pigment

| | Example 12- |
|---|---|
| Pass 1 | 0 part CB |
| MasterBatch | 5 parts V-760 |
| S-SBR BUNA VSL 5228-2 Rubber¹, | 129.19 |
| g | |
| BR BUDENE 1207 Rubber², g | 31.33 |
| Precipitated Silica³, g | 100.25 |
| V-760 Pigment¹⁶, g | 6.27 |
| Silane Coupler⁷, g | 8.52 |
| VIVATEC 500⁸, g | 6.27 |
| Pass 2 | |
| Master Batch, g | 273.99 |
| Zinc Oxide⁹, g | 3.05 |
| Stearic Acid¹⁰, g | 1.22 |
| SANTOFLEX 13 (6PPD)¹¹, g | 2.44 |
| Wax¹², g | 1.83 |
| Mill Finish | |
| Master Batch, g | 277.17 |
| Rubber Makers Sulfur¹³, g | 1.67 |
| SANTOCURE CBS¹⁴, g | 2.03 |
| DPG¹⁵, g | 2.39 |

¹⁶V-760 COOL COLORS IR DARK BROWN (Iron Chromite Brown Hematite) having a dark brown color, commercially available from Ferro Corporation (Cleveland, Ohio)

TABLE 6
IR reflectance (peak) of as-prepared rubber compounds

| | Peak % R (700 nm- | |
|---|---|---|
| Compound | 2500 nm)- | |
| Comparative | 4.12 | 10 parts CB |
| Example 1 | | 0 part pigment |
| Example 12 | 60.67 | 0 part CB 5 parts V-760 |

### Examples 13-15

### Rubber Composition Containing 10245 ECLIPSE IR GREEN Pigment

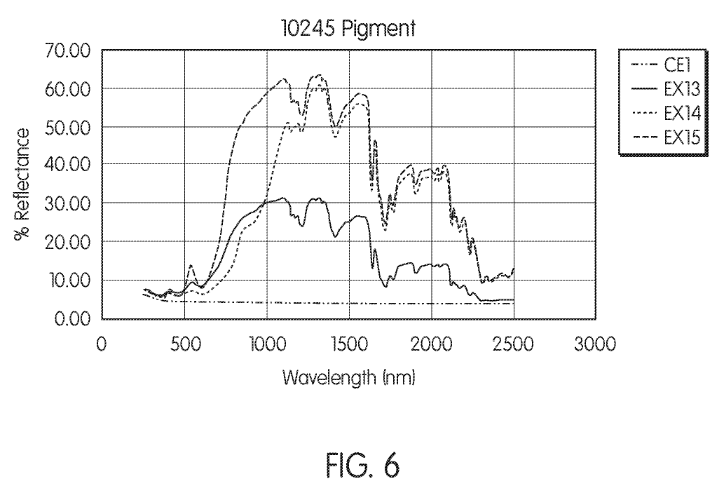

Rubber compounds containing various amounts of 10245 ECLIPSE IR GREEN Pigment (from Ferro Corporation) and in combination with V-785 Pigment were prepared using the method detailed in General Procedure using the formulations shown in Table 7. The IR reflectance test results are shown in Table 8 and FIG. 6. Compared to Comparative Example 1, it can be seen that by replacing carbon black with the IR reflective pigment, the IR reflectance of the rubber composition was significantly increased.

TABLE 7
Rubber compounds compositions containing 10245 Pigment

| | Example | Example 14 | |
|---|---|---|---|
| | 13 | 0 part CB | |
| | 0 part CB | 2 parts V-785 | Example 15 |
| Pass 1 | 0.5 parts | and 1 part | 0 part CB |
| MasterBatch | 10245 | 10245 | 5 parts 10245 |
| S-SBR BUNA VSL 5228-2 | 129.75 | 129.44 | 129.19 |
| Rubber¹, g | | | |
| BR BUDENE 1207 | 31.46 | 31.39 | 31.33 |
| Rubber², g | | | |
| Precipitated Silica³, g | 100.68 | 100.44 | 100.25 |
| V-785 Pigment⁵, g | — | 2.51 | — |
| 10245 Pigment⁶, g | 0.63 | 1.26 | 6.27 |
| Silane Coupler⁷, g | 8.56 | 8.54 | 8.52 |
| VIVATEC 500⁸, g | 6.29 | 6.28 | 6.27 |
| Pass 2 | | | |
| Master Batch, g | 269.64 | 272.06 | 273.99 |
| Zinc Oxide⁹, g | 3.06 | 3.05 | 3.05 |
| Stearic Acid¹⁰, g | 1.22 | 1.22 | 1.22 |
| SANTOFLEX 13 | 2.45 | 2.44 | 2.44 |
| (6PPD)¹¹, g | | | |
| Wax¹², g | 1.84 | 1.83 | 1.83 |
| Mill Finish | | | |
| Master Batch, g | 272.91 | 275.28 | 277.17 |
| Rubber Makers | 1.68 | 1.68 | 1.67 |
| Sulfur¹³, g | | | |
| SANTOCURE | 2.04 | 2.04 | 2.03 |
| CBS¹⁴, g | | | |
| DPG¹⁵, g | 2.40 | 2.39 | 2.39 |

TABLE 8
IR reflectance (peak) of as-prepared rubber compounds

| | Peak % R (700 nm- | |
|---|---|---|
| | 2500 nm) | |
| Comparative | 4.12 | 10 parts CB |
| Example 1 | | 0 part pigment |
| Example 13 | 31.51 | 0 part CB |
| | | 0.5 parts 10245 |
| Example 14 | 60.72 | 0 part CB |
| | | 2 parts V-785 and |
| | | 1 part 10245 |
| Example 15 | 63.32 | 0 part CB |
| | | 5 parts 10245 |

### Examples 16 to 17

### Rubber Composition Containing V-12112 Bright Golden Yellow Pigment

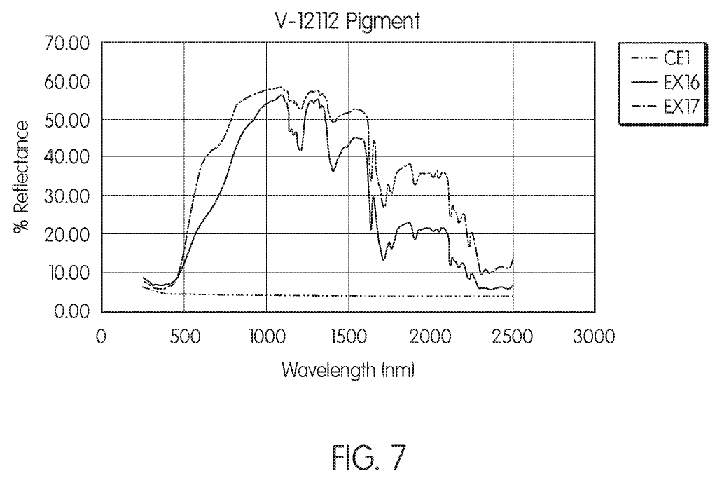

Rubber samples containing 1 and 5 parts of V-12112 Bright Golden Yellow Pigment (from Ferro Corporation) and no carbon black are shown. These rubber compounds were prepared using the method detailed in General Procedures using the formulations were shown in Table 9. The IR reflectance test results are shown in Table 10 and FIG. 7. Compared to Comparative Example 1, it can be seen that by replacing carbon black with the IR reflective pigment, the IR reflectance of the rubber composition was significantly increased.

TABLE 9
Rubber compounds compositions containing 10245 Pigment

| | Example 16- | Example 17- |
|---|---|---|
| Pass 1 | 0 part CB | 0 part CB |
| MasterBatch | 1 part V-12112 | 5 parts V-12112 |
| S-SBR BUNA VSL 5228-2 | 129.69 | 129.19 |
| Rubber¹, g | | |
| BR BUDENE 1207 Rubber², | 31.45 | 31.33 |
| g | | |
| Precipitated Silica³, g | 100.63 | 100.25 |
| V-12112 Pigment¹⁷, g | 1.26 | 6.27 |
| Silane Coupler⁷, g | 8.55 | 8.52 |
| VIVATEC 500⁸, g | 6.29 | 6.27 |
| Pass 2 | | |
| Master Batch, g | 270.12 | 273.99 |
| Zinc Oxide⁹, g | 3.06 | 3.05 |
| Stearic Acid¹⁰, g | 1.22 | 1.22 |
| SANTOFLEX 13 | 2.45 | 2.44 |
| (6PPD)¹¹, g | | |
| Wax¹², g | 1.83 | 1.83 |
| Mill Finish | | |
| Master Batch, g | 273.39 | 277.17 |
| Rubber Makers | 1.68 | 1.67 |
| Sulfur¹³, g | | |
| SANTOCURE | 2.04 | 2.03 |
| CBS¹⁴, g | | |
| DPG¹⁵, g | 2.40 | 2.39 |

¹⁷V-12112 Chrome Antimony Titanium BUFF Rutile having a yellow color, commercially available from Ferro Corporation (Cleveland, Ohio)

TABLE 10
IR reflectance (peak) of as-prepared rubber compounds

| | Peak % R (700 | |
|---|---|---|
| | nm-2500 nm) | |
| Comparative | 4.12 | 10 parts CB |
| Example 1 | | 0 part pigment |
| Example 16 | 55.81 | 0 part CB |
| | | 1 part V-12112 |
| Example 17 | 57.79 | 0 part CB |
| | | 5 parts V-12112 |

### Examples 18 and 19

### Rubber Composition Containing Silica Treated with Pigment

### Example 18: Silica Treated with Pigment

Synthesis of a precipitated silica slurry was conducted in a 150-liter reactor. The reactor was charged with 95 L city water and heated to 169° F. (76.1° C.). Over a 3.5 minute period of time, 1.5 L of stock aqueous sodium silicate containing 85 grams of Na₂O per liter and having a SiO₂:Na₂O molar ratio of 3.2:1 was added. In the following step, separate streams of stock aqueous sodium silicate solution (38 L) and 96 weight percent aqueous sulfuric acid (2.7 L) were added simultaneously over a period of 90 minutes. The pH of the solution was then adjusted to 8.5 with additional 96 weight percent aqueous sulfuric acid. The final pH adjustment was done by adding 96 weight percent aqueous sulfuric acid over 45 minutes to obtain the pH 3.9 of the reaction mixture. The reaction mixture was filtered in a filter press. The filter cake was washed with water until the conductivity of the filtrate had dropped to 552 microohms/cm. Water was added to each of the wet filter cakes and the resulting combinations were mixed with a Cowles blade to form a solid in liquid suspension containing 13.0 percent solids by weight. To prepare the treated silica slurry, 6.27 g V-785 Pigment was added to 771.2 g of the obtained silica slurry. The treated silica slurry was well mixed and then spray dried using a Buchi laboratory Spray Drier to obtain the V-785 Pigment treated silica powder.

### Example 19: Rubber Formulation with Pigment Treated Silica

A rubber formulation was prepared exactly as described in Example 9, substituting the precipitated silica and pigment components with 106.52 g of the treated silica of Example 18.

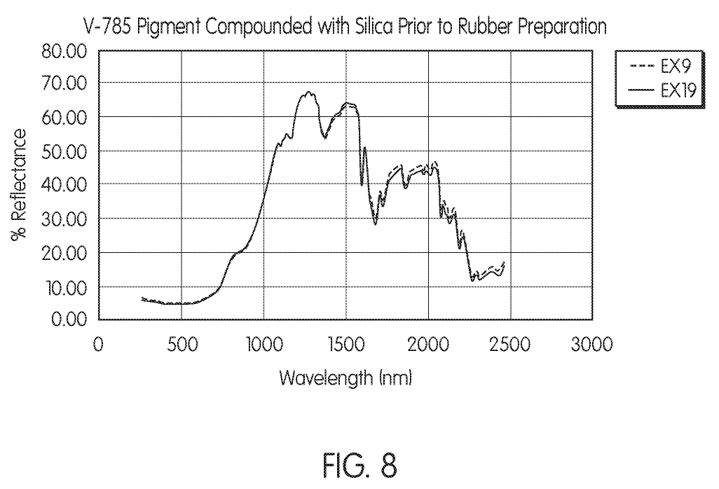

The IR reflectance test result is compared with that of Example 9, shown in Table 11 and FIG. 8. Mechanical properties of the rubber compounds were tested and showed in Table 12. The results demonstrate that silica can be used as a carrier of the IR reflective pigment without loss of properties at equivalent levels.

TABLE 11
IR reflectance (peak) of as-prepared rubber compounds

| | Peak % R | |
|---|---|---|
| | (700 nm-2500 nm) | |
| Example 9 | 67.26 | 0 part CB |
| | | 5 parts V-785 |
| Example 19 | 67.37 | 0 part CB 5 parts V-785 |
| | | (via pigment treated |
| | | silica) |

TABLE 12
Mechanical properties of as-prepared rubber compounds

| | Example 9 | Example 19 |
|---|---|---|
| | 0 parts CB, | 0 parts CB, 5 parts |
| | 5 parts | V-785 Pigment (via |
| | V-785 | treated silica) |
| ML(1 + 4) @ 100° C. | 93 | 77 |
| S′ ₘₐₓ | 33.7 | 30.9 |
| S′ ₘᵢₙ | 6.2 | 4.7 |
| S′ ₘₐₓ- S′ ₘᵢₙ | 27.5 | 26.2 |
| T50 | 12.1 | 9.8 |
| Tensile, MPa | 18.2 | 16.4 |
| Elongation, % | 389 | 416 |
| Modulus @ 100%, MPa | 3.0 | 2.6 |
| Modulus @ 300%, MPa | 13.4 | 11.2 |
| 300/100% Modulus ratio | 4.4 | 4.3 |
| Hardness @ 23° C. | 72 | 71 |
| Hardness @ 100° C. | 65 | 64 |
| Rebound @ 23° C., % | 27 | 28 |
| Rebound @ 100° C., % | 66 | 67 |
| G′ @ 60° C., MPa | 2.97 | 2.79 |
| Tan (δ) @ 60° C. | 0.145 | 0.121 |
| Tan (δ) @ 0° C. | 0.447 | 0.437 |
| G′ @ 1.0%, 30° C., MPa | 5.28 | 4.54 |

The invention can be described further in the following clauses.

Clause 1: A rubber composition comprising: rubber; and an infrared (IR) reflective pigment, wherein upon contact with IR radiation having a wavelength in the range of 700 to 2500 nm, the rubber composition has a maximum IR reflectance of at least 30%, preferably at least 40%, more preferably at least 45%.

Clause 2: The rubber composition of clause 1, wherein the rubber composition comprises less than 1 weight percent carbon black, preferably less than 0.5 weight percent, more preferably the rubber composition is completely free of carbon black.

Clause 3: The rubber composition of clause 1 or 2, wherein the rubber composition further comprises a silica filler.

Clause 4: The rubber composition of clause 3, wherein the silica comprises treated silica.

Clause 5: The rubber composition of clause 4, wherein the treated silica comprises silica treated with the IR reflective pigment.

Clause 6: The rubber composition of any of clauses 1-5, wherein the rubber composition comprises from 0.01 to 30 parts of the IR reflective pigment per 100 parts of the rubber, preferably from 1 to 30 parts.

Clause 7: The rubber composition of any of clauses 1-6, wherein the IR reflective pigment comprises a material having a L* value in the range of 0 to 40.

Clause 8: The rubber composition of any of clauses 1-7, wherein the rubber composition further comprises an IR transparent pigment, wherein the IR transparent pigment comprises a material having a L* value in the range of 0 to 40.

Clause 9: The rubber composition of any of clauses 1-8, wherein the IR reflective pigment is selected from the group consisting of Bragg scattering pigments, interference pigments, metal pigments, mixed metal pigments, and metal oxide pigments.

Clause 10: The rubber composition of any of clauses 1-9, wherein the IR reflective pigment comprises a metal pigment, preferably a mixed metal pigment or a metal oxide pigment.

Clause 11: The rubber composition of any of clauses 1-10, wherein the IR radiation has a wavelength in the range of 800 to 1500 nm.

Clause 12: A Light Detection and Ranging (LIDAR) detectable tire comprising a first section formed from a rubber composition, the rubber composition comprising: rubber; and an infrared (IR) reflective pigment, wherein upon contact with IR radiation having a wavelength in the range of 700 to 2500 nm, the tire has a maximum IR reflectance of at least 30%, preferably at least 40%, more preferably at least 45%.

Clause 13: The tire of clause 12, wherein the rubber composition comprises less than 1 weight percent carbon black, preferably less than 0.5 weight percent, more preferably the rubber composition is completely free of carbon black.

Clause 14: The tire of clause 12 or 13, wherein the rubber composition further comprises a silica filler.

Clause 15: The tire of clause 14, wherein the silica comprises treated silica.

Clause 16: The tire of clause 15, wherein the treated silica comprises silica treated with the IR reflective pigment.

Clause 17: The tire of any of clauses 12-16, wherein the rubber composition comprises from 0.01 to 30 parts of the IR reflective pigment per 100 parts of the rubber, preferably from 1 to 30 parts.

Clause 18: The tire of any of clauses 12-17, wherein the IR reflective pigment comprises a material having a L* value in the range of 0 to 40.

Clause 19: The tire of any of clauses 12-18, wherein the rubber composition further comprises an IR transparent pigment, wherein the IR transparent pigment comprises a material having a L* value in the range of 0 to 40.

Clause 20: The tire of any of clauses 12-19, wherein the IR reflective pigment is selected from the group consisting of Bragg scattering pigments, interference pigments, metal pigments, mixed metal pigments, and metal oxide pigments.

Clause 21: The tire of any of clauses 12-20, wherein the IR reflective pigment comprises a metal pigment, preferably a mixed metal pigment or a metal oxide pigment.

Clause 22: The tire of any of clauses 12-21, wherein the IR radiation has a wavelength in the range of 800 to 1500 nm.

Clause 23: The tire of any of clauses 12-22, wherein the first section comprises at least one of a tire tread, such as a tread cap or a tread base, a tire sidewall, a tire apex, a tire chafer, a tire sidewall insert, or a tire wirecoat.

Clause 24: The tire of any of clauses 12-23, further comprising a second section formed from a second rubber composition, the second rubber composition comprising rubber and carbon black.

Clause 25: The tire of any of clauses 12-24, wherein the tire is suitable for a vehicle, preferably an automobile, a bicycle, a motorcycle, a truck, an aircraft, an agricultural earthmover, or an off-road vehicle.

Clause 26: A method for detecting a Light Detection and Ranging (LIDAR) detectable tire comprising: emitting infrared (IR) radiation from a radiation source positioned such that at least a portion of the emitted IR radiation reflects off of the tire; and detecting at least a portion of the reflected IR radiation with an IR radiation detector.

Clause 27: The method of clause 26, wherein the tire comprises a first section formed from a rubber composition, the rubber composition comprising: rubber; and an IR reflective pigment, wherein upon contact with IR radiation having a wavelength in the range of 700 to 2500 nm, the rubber composition has a maximum IR reflectance of at least 30%, preferably at least 40%, more preferably at least 45%.

Clause 28: The method of clause 27, wherein the rubber composition comprises from 0.01 to 30 parts of the IR reflective pigment per 100 parts of the rubber, preferably from 0 to 30 parts.

Clause 29: The method of any of clauses 26-28, wherein the emitted IR radiation has a wavelength in the range of 700 to 2500 nm, preferably in the range of 800 to 1500 nm.

Clause 30: The method of any of clauses 27-29, wherein the first section comprises at least one of a tire tread, such as a tread cap or a tread base, a tire sidewall, a tire apex, a tire chafer, a tire sidewall insert, or a tire wirecoat.

Clause 31: A detection system for detecting a Light Detection and Ranging (LIDAR) detectable tire comprising: an infrared (IR) radiation source configured to emit IR radiation and positioned such that at least a portion of the emitted IR radiation reflects off of the tire; and an IR radiation detector configured to detect at least a portion of the reflected IR radiation.

Clause 32: The detection system of clause 31, wherein the tire comprises a first section formed from a rubber composition, the rubber composition comprising: rubber; and an IR reflective pigment, wherein upon contact with IR radiation having a wavelength in the range of 700 to 2500 nm, the rubber composition has a maximum reflectance of at least 30%, preferably at least 40%, more preferably at least 45%.

Clause 33: The detection system of clause 32, wherein the rubber composition comprises from 0.01 to 30 parts of the IR reflective pigment per 100 parts of the rubber, preferably from 1 to 30 parts.

Clause 34: The detection system of any of clauses 31-33, wherein the emitted IR radiation has a wavelength in the range of 700 to 2500 nm, preferably in the range of 800 to 1500 nm.

Clause 35: The detection system of any of clauses 31-34, wherein the IR radiation source and the IR radiation detector are mounted on a vehicle.

Clause 36: The detection system of clause 35, wherein the vehicle is an autonomous vehicle, and the tire is a tire of a separate vehicle or tire debris in a path of the autonomous vehicle.

Clause 37: The detection system of any of clauses 32-36, wherein the first section comprises at least one of a tire tread, such as a tread cap or a tread base, a tire sidewall, a tire apex, a tire chafer, a tire sidewall insert, or a tire wirecoat.

Whereas particular embodiments of this invention have been described above for purposes of illustration, it will be evident to those skilled in the art that numerous variations of the details of the present invention may be made without departing from the invention as defined in the appended claims.

The invention claimed is:

1. A rubber composition comprising:
rubber; and
an infrared (IR) reflective pigment,
wherein upon contact with IR radiation having a wavelength in the range of 700 to 2500 nm, the rubber composition has a maximum IR reflectance of at least 30%.

2. The rubber composition of claim 1, wherein the rubber composition comprises less than 1 weight percent carbon black.

3. The rubber composition of claim 1, wherein the rubber composition further comprises a silica filler.

4. The rubber composition of claim 3, wherein the silica comprises treated silica.

5. The rubber composition of claim 4, wherein the treated silica comprises silica treated with the IR reflective pigment.

6. The rubber composition of claim 1, wherein the rubber composition comprises from 0.01 to 30 parts of the IR reflective pigment per 100 parts of the rubber.

7. The rubber composition of claim 1, wherein the IR reflective pigment comprises a material having a L* value in the range of 0 to 40.

8. The rubber composition of claim 1, wherein the rubber composition further comprises an IR transparent pigment, wherein the IR transparent pigment comprises a material having a L* value in the range of 0 to 40.

9. The rubber composition of claim 1, wherein the IR reflective pigment is selected from the group consisting of Bragg scattering pigments, interference pigments, metal pigments, mixed metal pigments, and metal oxide pigments.

10. A Light Detection and Ranging (LIDAR) detectable tire comprising a first section formed from a rubber composition, the rubber composition comprising:
rubber; and
an infrared (IR) reflective pigment,
wherein upon contact with IR radiation having a wavelength in the range of 700 to 2500 nm, the tire has a maximum IR reflectance of at least 30%.

11. The tire of claim 10, wherein the rubber composition comprises less than 1 weight percent carbon black.

12. The tire of claim 10, wherein the rubber composition further comprises a silica filler.

13. The tire of claim 12, wherein the silica comprises treated silica.

14. The tire of claim 13, wherein the treated silica comprises silica treated with the IR reflective pigment.

15. The tire of claim 10, wherein the rubber composition comprises from 0.01 to 30 parts of the IR reflective pigment per 100 parts of the rubber.

16. The tire of claim 10, wherein the IR reflective pigment comprises a material having a L* value in the range of 0 to 40.

17. The tire of claim 10, wherein the rubber composition further comprises an IR transparent pigment, wherein the IR transparent pigment comprises a material having a L* value in the range of 0 to 40.

18. The tire of claim 10, wherein the first section comprises at least one of a tire tread, a tire sidewall, a tire apex, a tire chafer, a tire sidewall insert, or a tire wirecoat.

19. The tire of claim 10, further comprising a second section formed from a second rubber composition, the second rubber composition comprising rubber and carbon black.

20. A method for detecting a Light Detection and Ranging (LIDAR) detectable tire comprising:
emitting infrared (IR) radiation from a radiation source positioned such that at least a portion of the emitted IR radiation reflects off of a tire comprising a first section formed from a rubber composition, the rubber composition comprising:
rubber; and
an IR reflective pigment,
wherein upon contact with the IR radiation having a wavelength in the range of 700 to 2500 nm, the rubber composition has a maximum IR reflectance of at least 30%; and
detecting at least a portion of the reflected IR radiation with an IR radiation detector.
